(19) United States
(12) Patent Application Publication
(10) Pub. No.: US 2010/0219289 A1
(43) Pub. Date: Sep. 2, 2010

(54) PURGE DEVICE AND HYDRAULIC SYSTEM COMPRISING SUCH A PURGE DEVICE

(75) Inventor: Christophe Vieules, Toulouse (FR)

Correspondence Address: Dickinson Wright PLLC;James E. Ledbetter, Esq., International Square, 1875 Eye Street, N.W., Suite 1200, Washington, DC, 20006, US

(73) Assignee: AIRBUS FRANCE, Toulouse (FR)

(21) Appl. No.: 12/161,672

(22) PCT Filed: Jan. 26, 2007
(86) PCT No.: PCT/FR2007/000152

§ 371 Date: Jul. 21, 2008

(30) Foreign Application Priority Data
Feb. 8, 2006 (FR) 06 01103

(51) Int. Cl. F15B 21/04; B64C 25/22; B64F 1/02

(52) U.S. Cl. 244/102 R; 60/453; 244/110 A

(57) ABSTRACT

Purge device and hydraulic system comprising such a purge device. The purge device (1) comprises a connecting tube (8) connecting a main pipe (5A) of a hydraulic system (1A) to a secondary pipe (6), a valve (9) mounted on this connecting tube (8) and able to be in either a closed or an open position, and means (10) for controlling this valve (9).

The present invention relates to a purge device for bleeding a hydraulic system and to a hydraulic system comprising such a bleed device.

In the scope of the present invention, said bleed system comprises at least one control element and one (hydraulically) controlled mechanical element which are joined together by at least one main hydraulic pipe.

Although not exclusively, the present invention applies more particularly to a hydraulic system of an aircraft, which is intended to act on a landing gear of this aircraft. It is known that, in particular on long-haul airplanes such as the Airbus A330 and A340, the landing gear and the associated landing gear doors in the fairings are actuated using hydraulic power. To do this, said landing gear and said doors are kept in the raised and closed positions by latching boxes. Under normal operation, these latching boxes are hydraulically unlatched by a set of pipework which is connected to a control distributor. A second set of pipework for ensuring the latched position is also provided.

In service, it has been found that this pipework is subjected to very high loading that may go so far as to break the pipework supports or cause rupture of said pipework directly. These loadings are due to the presence of air in the pipework. This air cannot be bled naturally while the hydraulic system is in operation because the volumes of fluid displaced are very small.

More specifically, before an action is commanded via the control distributor, the runs of pipework are at low pressure (approximately 4.5 bar absolute). When an action is commanded, fluid at high pressure (approximately 206 bar) arrives at the outlet of the control distributor and compresses the air. Thus, the fluid acquires a very high speed (which may be as high as 200 m/s) as it reaches the inlet to the associated latching box. This speed creates a momentum which applies loadings to the pipework each time it changes direction. As a result, it is these loadings (due to the presence of air that cannot be bled out naturally) which is liable to rupture the pipework and break the supports thereof.

Various types of bleed apparatus that allows the aforementioned hydraulic system to be bled by action at the inlet to the latching box are known. These include the following in particular:
manual bleed apparatus, of the set screw type, which can be installed at said inlet, in order to remove air from the pipework. However, such manual bleed apparatuses have numerous disadvantages:
   they necessitate manual intervention involving tooling in order to actuate the bleed apparatus and to collect the bled fluid;
   a loss of fluid during bleeding which may entail the topping-up of the hydraulic circuit; and
   a risk of leakage to outside the hydraulic circuit, which risk is increased through the addition of said bleed apparatus; and
so-called automatic bleed apparatus which corresponds to a system for tapping off via calibrated orifices, which allow fluid to be circulated and thus allow air to be removed to a less vulnerable part of the hydraulic circuit. However, automatic bleed apparatuses such as this have the disadvantage that the internal circulation of fluid causes said fluid to heat up, and this is incompatible with a hydraulic generation system for an airplane or limits the use thereof. This is why it is generally possible only to install two bleed apparatuses of this type per airplane, even though there are eight latching boxes involved for example in the aforementioned types of airplane.

Another solution is to cause the oil pressure to rise more gradually either by slowing the speed at which the spool of the control distributor moves or by installing a restrictor on the hydraulic pipe. However, this solution has the disadvantage of slowing the sequence of raising/lowering the landing gear, and this has direct negative impacts on the performance of the aircraft in terms of noise.

As a result, none of the various customary bleed solutions is entirely satisfactory when it comes to bleeding a hydraulic system of the aforementioned type in an aircraft landing gear.

The present invention relates to a bleed device for a hydraulic system that is able to overcome the disadvantages described hereinabove.

To this end, according to the invention, said bleed device for a hydraulic system comprising at least one control element and one controlled element which are hydraulically joined together by at least one main pipe,

is notable in that it comprises:
at least one secondary pipe;
at least one connecting tube which links said secondary pipe to said main pipe so as to form a circuit which is closed;
at least one valve which is controllable, which is mounted on said connecting tube, and which is able to adopt one of two positions, namely:
   a closed position in which no fluid can flow between said main and secondary pipes; and
   an open position in which fluid can flow at least from said main pipe to said secondary pipe so as to bleed said main pipe; and
   control means for controlling said valve.

Thus, by virtue of the invention:
no tooling is needed, particularly as a result of the fact that the fluid remains inside said closed circuit and does not need to be collected outside the bleed device;
there is no risk of loss of fluid, because of the existence of said circuit which is a closed circuit;
there is no limit on the number of bleed devices (like the aforementioned one) that can be positioned on an item of equipment or an installation, particularly on an aircraft; and
there is no increase in the risk of leakage to outside.

In one particular embodiment, said bleed device additionally comprises:
a first means of evaluating a pressure difference within said connecting tube; and
an indicator means for displaying information relating to the pressure difference evaluated by said first means.

As a preference, said indicator means comprises an indicator which is formed in such a way that it is triggered automatically when the pressure difference within the connecting tube exceeds a predetermined pressure value. However, in the context of the present invention, said indicator means may display other types of information and, in particular, may simply provide a real-time display of a measured actual pressure difference.

Furthermore, in a first embodiment, said control means comprise a member:
which is positioned in the region of said connecting tube;
which can be actuated manually by an operator;
which is formed in such a way as to act on said valve in response to actuation by said operator; and
which can bring said valve at least into said open position.

In this case, advantageously, said control means additionally comprise at least one element (for example a spring and/or a hydraulic control) allowing automatic operation of said member so that the latter brings the valve into said closed position when not manually actuated by an operator.

Furthermore, in a second embodiment, as an alternative or in addition to said first embodiment, said control means comprise an electric control element which is remotely sited.

Thus, when several bleed devices of the aforementioned type are installed on an item of equipment or an installation, it is possible to position the various electric control elements at a single point (sited remotely) so that the bleeds performed by these various bleed devices can be managed more easily.

Furthermore, in a third embodiment, as an alternative or in addition to said first and second embodiments already mentioned, said control means comprise an automatic control element intended to control said valve automatically on the basis of information supplied by at least one information source. By way of illustration, said automatic control element may control the valve for performing the bleed, on the basis of the pressure difference measured inside the connecting tube or as a function of the status of the equipment on which said hydraulic system is mounted, for example as a function of the phase of movement (when rolling along a runway in particular) of an aircraft.

Furthermore, in one particular embodiment, said bleed device additionally comprises a check valve which is mounted on said connecting tube and is formed in such a way as to prevent any fluid from flowing from said main pipe to said secondary pipe.

It will be noted that the bleed device according to the invention, as described hereinabove, can be applied to any hydraulic system that comprises at least one control element and one controlled element hydraulically connected together by at least one main pipe.

However, in a preferred application, said hydraulic system is a hydraulic system of an aircraft landing gear, in which:
said control element is a control distributor;
said controlled element is a latching box of said landing gear and an associated landing gear door; and
said main pipe is an unlatching pipe for said latching box.

In addition to the aforementioned advantages, the bleed device according to the invention has, in this preferred application, the additional advantage of not lengthening the duration of the sequences of raising/lowering the landing gear.

In addition, in this preferred application, said secondary pipe of the bleed device preferably corresponds to a latching confirmation pipe for said latching box of the hydraulic system. This makes it possible to simplify the way in which said bleed device can be produced because by way of secondary pipe it is possible to use a pipe which is already present in the hydraulic system.

Furthermore, in another application, said hydraulic system is advantageously a hydraulic system for a braking gear of a moving body, said controlled element in this case corresponding to a brake of said braking gear.

The figures of the attached drawing will make it easy to understand how the invention may be embodied. In these figures, identical references denote elements which are similar.

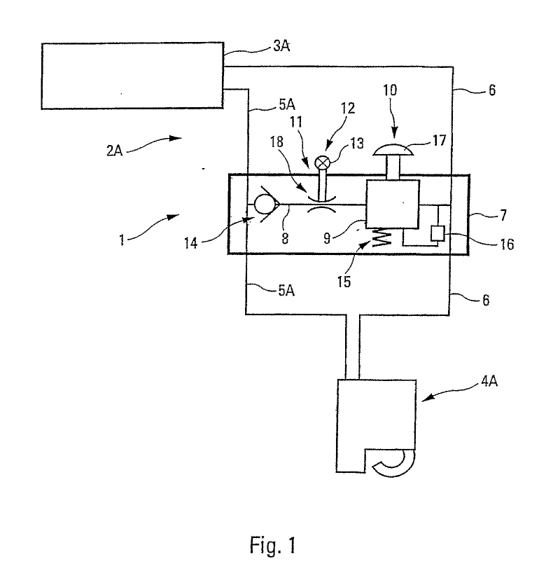

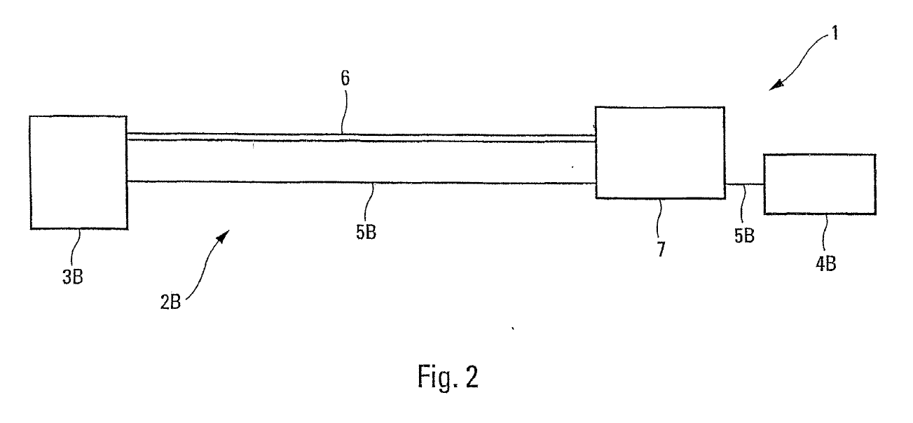

FIGS. 1 and 2 are block diagrams of a bleed device according to the invention in two different applications.

The bleed device 1 according to the invention is intended to bleed a hydraulic system depicted according to two embodiments 2A and 2B in FIGS. 1 and 2 respectively.

In the context of the present invention, said hydraulic system 2A, 2B comprises at least:
a control element 3A, 3B;
a controlled mechanical element 4A, 4B which is hydraulically controlled; and
at least one main pipe 5A, 5B which hydraulically joins together said control element 3A, 3B and said controlled element 4A, 4B.

In order to bleed said hydraulic system 2A, 2B, the bleed device 1 according to the invention comprises:
at least a secondary pipe 6; and
a bleed assembly 7 which comprises:
   at least one connecting tube 8 which connects said secondary pipe 6 to said main pipe 5A, 5B in such a way as to form a circuit which is closed;
   at least one valve 9 which is controllable, which is mounted on said connecting tube 8, and which can adopt one of two positions, namely:
      a closed position in which no fluid can flow between said main pipe 5A, 5B and said secondary pipe 6; and
      an open position in which fluid can flow at least from said main pipe 5A, 5B to said secondary pipe 6 so as to bleed said main pipe 5A, 5B; and
   control means 10 for controlling said valve 9.

In consequence, bleeding is performed by opening the valve 9 using control means 10. The fluid lying in the main pipe 5A, 5B then flows through the connecting tube 8 into the secondary line 6 thus bleeding air from said main pipe 5A, 5B.

It will be noted that said valve 9 is preferably brought into the open position until a sufficient amount of air has been removed. To reduce the speed of the fluid and therefore the loadings applied to said main pipe 5A, 5B and to its supports there is no need to bleed all of the air out of said main pipe 5A, 5B.

Thus, by virtue of the invention:
no tooling is needed, particularly as a result of the fact that the fluid remains inside said closed circuit (formed by said main pipe 5A, 5B, said connecting tube 8 and said secondary pipe 6) and does not need to be collected outside the bleed device 1;
there is no risk of loss of fluid, because of the existence of said circuit which is closed;
there is no limit on the number of bleed devices 1 (like the aforementioned one) that can be positioned on an item of equipment or an installation, particularly on an aircraft; and
there is no increase in the risk of leakage to outside.

As already mentioned, in order to be effective, the bleeding has to be done for as long as a significant volume of air remains in the main pipe 5A, 5B. Hence, in one particular embodiment, said bleed device 1 additionally comprises:
a means 11 for evaluating the pressure difference inside said connecting tube 8; and
an indicating means 12 for displaying information relating to the pressure difference evaluated by said means 11.

In a preferred embodiment, said means 11 comprises a restrictor 18 and said indicator means 12 comprises an indicator 13 which is formed in such a way as to be triggered automatically when the pressure difference in the connecting tube 8 exceeds a predetermined pressure value determined by said restrictor 18.

This latter embodiment takes account of the fact that, when air flows through the restrictor 18, the pressure drop is small. By contrast, when oil passes through this same restrictor 18, the pressure difference increases. The increase in pressure difference shows that the fluid in the main pipe 5A is viscous and incompressible enough to limit the acceleration of the oil when the controlled element 4A, 4B is hydraulically controlled. In this particular embodiment, the valve 9 is therefore open until the indicator 13 is triggered.

However, in the context of the present invention, said indicator means 12 may display other types of information and, in particular, may simply provide a real-time indication of an actual measured pressure difference.

Furthermore, in order to guarantee a high level of reliability and of safety, it is necessary to ensure that, under normal circumstances (when bleeding is not taking place), there is no flow of fluid between the main pipe 5A, 5B and the secondary pipe 6. To do this, the following are provided:
a conventional check valve 14 which is mounted on said connecting tube 8 and which is formed in such a way as to prevent any fluid from flowing from said main pipe 5A, 5B to said secondary pipe 6; and
elements 15, 16, for example a spring 15 and a hydraulic control 16, which are able to act automatically on the control means 10 or on the valve 9 in such a way as to ensure that said valve 9 remains in the closed position when not commanded.

In one preferred embodiment, said control means 10 comprise a member 17:
which is arranged in the region of said connecting tube 8;
which is capable of being operated manually by an operator, for example by simple manual pressure;
which is formed in such a way as to act on said valve 9 in response to actuation by said operator; and
which is able to bring said valve 9 at least into said open position.

Furthermore, in a first alternative form, in order to make maintenance operations easier, said control means may comprise an electric control element (not depicted) which is sited remotely. In this case, it is also necessary to provide a valve 9 which is electrically operated, and an electrical indicator. By virtue of this first alternative form, when several bleed devices 1 of the aforementioned type are installed on one item of equipment or one installation, it is possible to site the various electric control elements at a single point (located remotely) making for easier management of the bleeds performed by these various bleed devices 1. In addition, in this alternative form, the various electric control elements can be mounted on a control panel on which there may also be installed a luminous indicator that indicates the status of the indicator means 12.

Furthermore, in a second alternative form, said control means 10 comprise an automatic control element (not depicted) intended to control said valve 9 automatically on the basis of information supplied by at least one information source (for example by said means 11). By way of illustration, said automatic control element may control the valve 9 in such a way as to perform bleeding on the strength of the pressure difference measured inside the connecting tube 8 or as a function of the status of the equipment on which said hydraulic system 2A, 2B is mounted, for example as a function of the phase of movement (when rolling along a runway in particular) of an aircraft.

It will be noted that the bleed device 1 according to the invention as described hereinabove can be applied to any hydraulic system 2a, 2B comprising at least one control element 3A, 3B and one controlled element 4A, 4B which are hydraulically joined together by at least one main pipe 5A, 5B.

However, in a preferred application, said hydraulic system 2A is a hydraulic system of an aircraft landing gear in which, as depicted in FIG. 1:
said control element 3A is a control distributor;
said controlled element 4A is a latching box of said landing gear and an associated landing gear door; and
said main pipe 5A is an unlatching pipe for said latching box 4A.

In addition to the aforementioned advantages, the bleed device 1 according to the invention has, in this preferred application, the advantage of not lengthening the duration of the sequences of raising/lowering the landing gear.

In addition, in this preferred application, said secondary pipe 6 of the bleed device 1 preferably corresponds to a pipe ensuring latching of said latching box 4A of the hydraulic system 2A. That makes it possible to simplify the production of said bleed device 1 because use is made, by way of secondary pipe 6, of a pipe which is already present in said hydraulic system 2A.

Furthermore, in another application depicted schematically in FIG. 2, said hydraulic system 2B is a hydraulic system of a braking gear of a moving body, particularly of an airplane rolling along the ground. In this case, the controlled element 4B corresponds to a brake of said braking gear.

1-12. (canceled)

13. A bleed device (1) for a hydraulic system (2A, 2B) comprising at least one control element (3A, 3B) and one controlled element (4A, 4B) which are hydraulically joined together by at least one main pipe (5A, 5B), said device comprising:
at least one secondary pipe (6);
at least one connecting tube (8) which links said secondary pipe (6) to said main pipe (5A, 5B) so as to form a closed circuit;
at least one valve (9) which is controllable, which is mounted on said connecting tube (8), and which is able to adopt one of two positions, namely:
a closed position in which no fluid can flow between said main and secondary pipes (5A, 5B; 6); and
an open position in which fluid can flow at least from said main pipe (5A, 5B) to said secondary pipe (6) so as to bleed said main pipe (5A, 5B); and
control means (10) for controlling said valve (9), wherein:
said valve (9) can be electrically actuated; and—said control means (10) comprise an electric control element which is remotely sited.

14. The device as claimed in claim 13, wherein it additionally comprises:
a first means (11) of evaluating a pressure difference within said connecting tube (8); and
an indicator means (12) for displaying information relating to the pressure difference evaluated by said first means (11).

15. The device as claimed in claim 14, wherein said indicator means (12) comprises an indicator (13) which is formed in such a way that it is triggered automatically when the pressure difference within the connecting tube (8) exceeds a predetermined pressure value.

16. The device as claimed in claim 13, wherein said control means (10) comprise a member (17):
which is positioned in the region of said connecting tube (8);
which can be actuated manually by an operator;
which is formed in such a way as to act on said valve (9) in response to actuation by said operator; and
which can bring said valve (9) at least into said open position.

17. The device as claimed in claim 16, wherein said control means (10) additionally comprise at least one element (15, 16) allowing automatic operation of said member (17) so that the latter brings the valve (9) into said closed position when not manually actuated by an operator.

18. The device as claimed in claim 13, wherein said control means (10) comprise an automatic control element intended to control said valve (9) automatically on the basis of information supplied by at least one information source.

19. The device as claimed in claim 13, wherein it additionally comprises a check valve (14) which is mounted on said connecting tube (8) and is formed in such a way as to prevent any fluid from flowing from said main pipe (5A, 5B) to said secondary pipe (6).

20. A hydraulic system comprising at least one control element (3A, 3B) and a controlled element (4A, 4B) which are joined together hydraulically by at least one main pipe (5A, 5B) wherein it additionally comprises at least one bleed device (1) like the one specified in claim 13.

21. The system as claimed in claim 20, wherein it comprises several bleed devices (1) like the one specified in claim 1 and the remotely sited electric control elements of said bleed devices (1) are mounted on a single control panel.

22. The system as claimed in claim 20, wherein:
said hydraulic system (2A) is a hydraulic system of an aircraft landing gear;
said control element (3A) is a control distributor;
said controlled element (4A) is a latching box of said landing gear and an associated landing gear door; and
said main pipe (5A) is an unlatching pipe for said latching box (4A).

23. The system as claimed in claim 22, wherein said secondary pipe (6) of the bleed device (1) corresponds to a latching confirmation pipe for said latching box (4A) of the hydraulic system (2A).

24. The system as claimed in claim 20, wherein:
said hydraulic system (2B) is a hydraulic system for a braking gear of a moving body; and
said controlled element (4B) is a brake of said braking gear.
